(19) United States
(12) Patent Application Publication
(10) Pub. No.: US 2007/0014963 A1
(43) Pub. Date: Jan. 18, 2007

(54) METAL ALLOYS FOR THE REFLECTIVE LAYER OF AN OPTICAL STORAGE MEDIUM

(76) Inventor: Han H. Nee, Newport Coast, CA (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/457,002

(22) Filed: Jul. 12, 2006

Related U.S. Application Data
(60) Provisional application No. 60/698,405, filed on Jul. 12, 2005.

(51) Int. Cl. B32B 3/02

(52) U.S. Cl. 428/64.1

(57) ABSTRACT

A copper-based alloy film is provided for the highly reflective layer of optical discs. Alloy additions to copper include, silver, magnesium, nickel, zinc, cobalt, boron, aluminum, and indium. These alloys have moderate to high reflectivity and reasonable corrosion resistance in ambient environments.

### FIELD OF THE INVENTION

This invention relates to reflective film layers and coatings, in particular to highly reflective film layers and coatings used in optical storage media that comprise copper-based alloys.

### BACKGROUND OF THE INVENTION

Four layers are generally present in the construction of a conventional, prerecorded, optical disc such as compact audio disc. A first layer is usually made from optical grade, polycarbonate resin. This layer is manufactured by well-known techniques that usually begin by injection or compression molding the resin into a disc. The surface of the disc is molded or stamped with extremely small and precisely located pits and lands. These pits and lands have a predetermined size and, as explained below, are ultimately the vehicles for storing information on the disc.

After stamping, an optically reflective layer is placed over the information pits and lands. The reflective layer is usually made of aluminum or an aluminum alloy and is typically between about 40 to about 100 nanometers (nm) thick. The reflective layer is usually deposited by one of many well-known vapor deposition techniques such as sputtering or thermal evaporation. Kirk-Othmer, Encyclopedia of Chemical Technology, 3^{rd} ed. Vol. 10, pp. 247 to 283, offers a detailed explanation of these and other deposition techniques such as glow discharge, ion plating, and chemical vapor deposition, and this specification hereby incorporates that disclosure by reference.

Next, a solvent-based or an UV (ultraviolet) curing-type resin is applied over the reflective layer, which is usually followed by a label. The third layer protects the reflective layer from handling the ambient environment. And the label identifies the particular information that is stored on the disc, and sometimes, may include artwork.

The information pits residing between the polycarbonate resin and the reflective layer usually take the form of a continuous spiral. The spiral typically begins at an inside radius and ends at an outside radius. The distance between any 2 spirals is called the “track pitch” and is usually about 1.6 microns for compact audio disc. The length of one pit or land in the direction of the track is from about 0.9 to about 3.3 microns. All of these details are commonly known for compact audio discs and reside in a series of specifications that were first proposed by Philips NV of Holland and Sony of Japan as standards for the industry.

The disc is read by pointing a laser beam through the optical grade polycarbonate substrate and onto the reflective layer with sufficiently small resolution to focus on the information pits. The pits have a depth of about ±4 of the wavelength of the laser light, and the light generally has a wavelength in the range of about 780 to 820 nanometers. Destructive (dark) or constructive (bright) interference of the laser light is then produced as the laser travels along the spiral track, focusing on an alternating stream of pits and lands in its path.

This on and off change of light intensity from dark to bright or from bright to dark forms the basis of a digital data stream of 1's and 0's. When there is no light intensity change in a fixed time interval, the digital signal is “0,” and when there is light intensity change from either dark to bright or bright to dark, the digital signal is “1.” The continuous stream of ones and zeros that results is then electronically decoded and presented in a format that is meaningful to the user such as music or computer programming data.

As a result, it is important to have a highly reflective coating on the disc to reflect the laser light from the disc and onto a detector in order to read the presence of an intensity change. In general, the reflective layer is usually aluminum, copper, silver, or gold, all of which have a high optical reflectivity of more than 80 percent from 650 nm to 820 nm wavelength. Aluminum and aluminum alloys are commonly used because they have a comparatively lower cost, adequate corrosion resistance, and are easily placed onto the polycarbonate disc.

Occasionally and usually for cosmetic reason, a gold or copper based alloy is used to offer the consumer a “gold” colored disc. Although gold naturally offers a rich color and satisfies all the functional requirements of a highly reflective layer, it is comparatively much more expensive than aluminum. Therefore, a copper-based alloy that contains zinc or tin is sometimes used to produce the gold colored layer. But unfortunately, the exchange is not truly satisfactory because the copper alloy's corrosion resistance, in general, is considered worse than aluminum, which results in a disc that has a shorter life span than one with an aluminum reflective layer.

For the convenience of the reader, additional details in the manufacture and operation of an optically readable storage system can be found in U.S. Pat. No. 4,998,239 to Strandjord et al. and U.S. Pat. No. 4,709,363 to Dirks et al., the disclosures of which are hereby incorporated by reference.

Another type of disc in the compact disc family that has become popular is the recordable compact disc or “CD-R.” This disc is similar to the CD described earlier, but it has a few changes. The recordable compact disc begins with a continuous spiral groove instead of a continuous spiral of pits and has a layer of organic dye between the polycarbonate substrate and the reflective layer. The disc is recorded by periodically focusing a laser beam into the grooves as the laser travels along the spiral track. The laser heats the dye to a high temperature, which in turn places pits in the groove that coincide with an input data stream of ones and zeros by periodically deforming and decomposing the dye.

For the convenience of the reader, additional details regarding the operation and construction of these recordable discs can be found in U.S. Pat. No. 5,325,351 to Uchiyama et al., and U.S. Pat. Nos. 5,391,462; 5,415,914; and 5,419,939 to Arioka et al., and U.S. Pat. No. 5,620,767 to Harigaya et al., the disclosures of which are hereby incorporated into this specification by reference.

The key component of a CD-R disc is the organic dye, which is typically made from solvent and one or more organic compounds from the cyanine, phthalocyanine or azo family. The disc is normally produced by spin coating the dye onto the disc and sputtering the reflective layer over the dye after the dye is sufficiently dry. But because the dye may contain halogen ions or other chemicals that can corrode the reflective layer, many commonly used reflective layer materials such as aluminum may not be suitable to give the CD-R disc a reasonable life span. So being, frequently gold must be used to manufacture a recordable CD. But while gold satisfies all the functional requirements of CD-R discs, it is a very expensive solution.

Recently, other types of recordable optical disks have been developed. These optical disks use a phase-change or magneto-optic material as the recording medium. An optical laser is used to change the phase or magnetic state (microstructural change) of the recording layer by modulating a beam focused on the recording medium while the medium is rotated to produce microstructural changes in the recording layer. During playback, changes in the intensity of light from the optical beam reflected through the recording medium are sensed by a detector. These modulations in light intensity are due to variations in the microstructure of the recording medium produced during the recording process. Some phase-change and/or magneto-optic materials may be readily and repeatedly transformed from a first state to a second state and back again with substantially no degradation. These materials may be used as the recording media for a compact disc-rewritable disc, or commonly known as CD-RW.

To record and read information, phase change discs utilize the recording layer's ability to change from a first dark to a second light phase and back again. Recording on these materials produces a series of alternating dark and light spots according to digital input data introduced as modulations in the recording laser beam. These light and dark spots on the recording medium correspond to 0's and 1's in terms of digital data. The digitized data is read using a low laser power focused along the track of the disc to play back the recorded information. The laser power is low enough such that it does not further change the state of the recording media but is powerful enough such that the variations in reflectivity of the recording medium may be easily distinguished by a detector. The recording medium may be erased for re-recording by focusing a laser of intermediate power on the recording medium. This returns the recording medium layer to its original or erased state. A more detailed discussion of the recording mechanism of optically recordable media can be found in U.S. Pat. Nos. 5,741,603; 5,498,507; and 5,719,006 assigned to the Sony Corporation, the TDK Corporation, and the NEC Corporation, all of Tokyo, Japan, respectively, the disclosures of which are incorporated herein by reference in their entirety.

Still another type of disc in the optical disc family that has become popular is a prerecorded optical disc called the digital videodisc or “DVD.” This disc has two halves. Each half is made of polycarbonate resin that has been injection or compression molded with pit information and then sputter coated with a reflective layer, as described earlier. These two halves are then bonded or glued together with an UV curing resin or a hot melt adhesive to form the whole disc. The disc can then be played from both sides as contrasted from the compact disc or CD where information is usually obtained only from one side. The size of a DVD is about the same as a CD, but the information density is considerably higher. The track pitch is about 0.7 micron and the length of the pits and lands is from approximately 0.3 to 1.4 microns.

One variation of the DVD family of discs is the DVD-dual layer disc. This disc also has two information layers; however, both layers are played back from one side. In this arrangement, the highly reflectivity layer is usually the same as that previously described. But the second layer is only semi-reflective with a reflectivity in the range of approximately 18 to 30 percent at 650 nm wavelength. In addition to reflecting light, this second layer must also pass a substantial amount of light so that the laser beam can reach the highly reflective layer underneath and then reflect back through the semi-reflective layer to the signal detector.

In a continued attempt to increase the storage capacity of optical discs, a multi-layer disc can be constructed as indicated in the publication “SPIE Conference Proceeding Vol. 2890, page 2-9, November, 1996” where a tri-layer or a quadri-layer optical disc was revealed. All the data layers were played back from one side of the disc using laser light at 650 nm wavelength. A double-sided tri-layered read-only-disc that included a total of six layers can have a storage capacity of about 26 gigabytes of information.

Currently, there is an interest in adapting CD-RW techniques to the DVD field to produce a rewritable DVD (DVD-RW). Some difficulties in the production of a DVD-RW have arisen due to the higher information density requirements of the DVD format. For example, the reflectivity of the reflective layer must be increased relative that of the standard DVD reflective layer to accommodate the reading, writing, and erasing requirements of the DVD-RW format. Also, the thermal conductivity of the reflective layer must also be increased to adequately dissipate the heat generated by both the higher laser power requirements to write and erase information and the microstructural changes occurring during the information transfer process. The potential choice of the reflective layer is currently pure gold, pure silver and aluminum alloys. Gold seems to have sufficient reflectivity, thermal conductivity, and corrosion resistance properties to work in a DVD-RW disk. Additionally, gold is relatively easy to sputter into a coating of uniform thickness. But once again, gold is also comparatively more expensive than other metals, making the DVD-RW format prohibitively expensive. Pure silver has higher reflectivity and thermal conductivity than gold, but its corrosion resistance is relatively poor as compared to gold. Aluminum alloy's reflectivity and thermal conductivity is considerably lower than either gold or silver, and therefore is not necessarily a good choice for the reflective layer in DVD-RW or DVD+RW.

Recent advances in the development of thin silver alloy films for use as both semi-reflective and highly reflective layers in DVD-9s has made it feasible to create tri-layer and even quadruple-layer optical discs with all playback information layers on the same side of the disc. See for example, U.S. Pat. Nos. 6,007,889, and 6,280,811. Thus multiple-layer disc can be constructed and manufactured at low cost. Combined with objective lens having a numerical aperture (NA) of 0.60, and playback lasers having a wavelength of about 650 nm, multiple-layer optical storage devices with the capacity to store 14 gigabytes of information (DVD-14) or 18 gigabytes (DVD-18) of information storage capacity can be made.

For the convenience of the reader, additional details regarding the manufacture and construction of DVD discs can be found in U.S. Pat. No. 5,640,382 to Florczak et al., the disclosure of which is hereby incorporated by reference.

In optical data storage devices in which at least one reflective coating is separated from the detector by additional layers or by a layer that interferes with the transmission of light reflective coating must be highly reflective in order to reflect sufficient light back to the detector to produce a reliable signal. In such devices including, for example, CD, CD-R, DVD+R and DVD-R the reflectivity of an aluminum surface may be too low to deliver a satisfactory signal to the detector. In these devices a reflective coating of pure or substantially pure gold or silver may be used to form the reflective surface. While pure or substantially pure silver or gold work in such applications these materials are relatively expensive and silver and many silver based alloys are susceptible to corrosion. This is a particularly important consideration in writable devices that include a dye layer comprised of a material that may corrode reflective coatings which include aluminum, or silver.

Therefore, what is needed are reflective layers formed of alloys that have the advantages of gold or silver when used as a reflective layer in an optical storage medium, but are not as expensive as gold or silver. Ideally these alloys will be less expensive than pure silver or substantially pure silver. One object of the current invention addresses that need.

### SUMMARY OF THE INVENTION

One embodiment provides new metallic reflective layers or coatings that are highly reflective, easily applied by sputtering, corrosion resistant and less expensive than gold or silver based materials. A layer of these alloys is suited for used in multi-layer optical storage devices such as, for example, CD-R, DVD+R and DVD-R.

Another objective is to provide a lower cost alternative to reflective film layers or coatings in optical storage devices that are currently composed of gold, silver, aluminum or alloys composed substantially of any one of these metals.

A further objective is to provide a copper-based alloy with chemical, thermal, and optical properties that satisfy the functional requirements of the reflective film layer or coating in a CD, CD-R DVD+R and DVD-R and other current or future generations of optical discs which require a reflective, inexpensive and corrosion resistant film layer or coating. It is still another objective to provide a relatively inexpensive reflective layer that resembles gold.

In another aspect, the medium may further comprise a second layer having a pattern of features in at least one major surface and a second coating adjacent to the second layer. The second layer may include a dielectric material. Additionally, the medium may include a third layer having a pattern of features in at least one major surface, the third layer including an optically recordable material and a forth layer having a pattern of features in at least one major surface, the forth layer may include a dielectric material.

Another aspect is an optical storage medium comprising a substrate with a pattern of features in at least one major surface and a recording layer adjacent the feature pattern. A semi-reflective layer then resides adjacent the recording layer. The optical storage medium may also have a second substrate with a pattern of features in at least one major surface, a second recording layer adjacent the feature pattern, and a reflective layer adjacent the recording layer. A space layer is then located between the first and second substrates. The reflective coatings are made of copper and at least one other element, selected from the group consisting of silver, magnesium, zinc, nickel, and mixtures thereof.

In still another aspect this invention is an optical storage medium comprising a first layer having a pattern of features in at least one major surface and a semi-reflective layer adjacent to the first feature pattern. The semi-reflective layer or coating can be comprised of any of the metal alloys of the invention suitable for use in a reflective layer and compatible for use with a laser in the range of 630 nm-800 nm. The storage medium may further includes a second layer having a pattern of features in at least one major surface and a reflective or highly reflective layer or coating adjacent to the second pattern of features. In one embodiment of the first pattern of features is a spiral groove.

In yet another aspect the invention provides an optical storage device including, in addition to a first layer and second layer each having feature patterns, a forth layer including an optically recordable material positioned between a third layer including a dielectric material and a fifth layer including a dielectric material. Optical recording layer 4 and dielectric layers 3 and 5 are positioned between the first layer and the second layer. In one embodiment of the invention the feature pattern in either, or both, the first and second layers comprise a spiral groove either with or without data pits.

In one embodiment of the invention the recordable material in layer 4 is a phase changeable material.

In still another embodiment of the invention the recordable material in layer 4 is magnetic optical recordable material.

In yet another embodiment of the invention the recordable material in layer 4 is an optically active dye.

In another aspect of the invention, the optically recordable material is a phase-changeable material. The optically recordable material may comprise a phase changeable materials selected from the group consisting of Ge—Sb—Te, As—In—Sb—Te, Cr—Ge—Sb—Te, As—Te—Ge, Te—Ge—Sn, Te—Ge—Sn—O, Te—Se, Sn—Te—Se, Te—Ge—Sn—Au, Ge—Sb—Te, Sb—Te—Se, In—Se—Tl, In Sb, In—Sb—Se, In—Se—Tl—Co, Bi—Ge, Bi—Ge—Sb, Bi—Ge—Te, and Si—Te—Sn. The optically recordable material may be a magneto-optic material selected for example from the group consisting of Tb—Fe—Co and Gd—Tb—Fe.

In another aspect of the invention, a reflective metal alloy in the reflective layer or coating of an optical recording medium is an alloy comprised of copper and other elements, selected from the group consisting of silver, magnesium, zinc, nickel and combinations thereof.

In still another aspect this invention is an optical information recording medium, comprising a substrate having a pattern of features in at least one major surface, a recording layer adjacent the feature pattern; a reflective layer adjacent to the recording layer. The reflective layer includes a metal alloy, in which the metal alloy comprises copper and at least one other element selected from the group consisting of silver, zinc, magnesium, nickel and mixtures thereof, wherein said other elements such as silver and magnesium are present from about 0.01 a/o percent to about 5.0 a/o percent of the amount of copper present; zinc is present from about 0.01 a/o percent to about 10.0 a/o percent of the amount of copper present; and nickel is present from about 0.01 a/o percent to about 20.0 a/o percent of the amount of copper present or preferable from about 0.01 a/o percent to about 10.0 a/o percent of the amount of copper present.

In one aspect of the invention, the first recording layer of an optical information recording medium may directly contact the first metal layer.

One embodiment, is an optical storage medium comprising at least one layer that has a pattern of features in at least one major surface; at least one reflective film layer or coating is adjacent to at least one layer that has a pattern of features in at least one major surface; at least one reflective film layer or coating includes a metal alloy. The metal alloy of at least one reflective film layer or coating includes copper, silver and magnesium; the relationship between the amounts of copper, silver and magnesium in the metal alloy is defined by CuₓAg_{y}Mg_{z}, where 0.9<x<0.9998, 0.0001<y<0.05 and 0.0001<z<0.05. In another embodiment, the relationship between the amounts of copper, silver and magnesium is defined by CuₓAg_{y}Mg_{z} where 0.97<x<0.997, 0.001<y<0.015, 0.001<z<0.03. In still another embodiment the copper, silver, magnesium alloy further includes Zn, wherein the amount of zinc in the alloy is between 0.01 a/o percent and 10.0 a/o percent.

Still another embodiment is an optical storage medium comprising at least one layer that has a pattern of features in at least one major surface; at least one reflective film layer or coating is adjacent to at least one layer that has a pattern of features in at least one major surface; at least one reflective film layer or coating includes a metal alloy. The metal alloy of at least one reflective film layer or coating includes copper, silver and zinc; the relationship between the amounts of copper, silver and zinc in the metal alloy is defined by CuₓAg_{y}Znᵤ, where 0.85<x<0.9998, 0.0001<y<0.05 and 0.0001<u<0.10.

Another embodiment is an optical storage medium comprising at least one layer that has a pattern of features in at least one major surface; at least one reflective film layer or coating is adjacent to at least one layer that has a pattern of features in at least one major surface; at least one reflective film layer or coating includes a metal alloy. The metal alloy of at least one reflective film layer or coating includes copper, magnesium and nickel; the relationship between the amounts of copper, magnesium and nickel in the metal alloy is defined by CuₓMg_{z}Niᵥ, where 0.85<x<0.9998, 0.0001<z<0.05 and 0.0001<v<0.10.

Still another embodiment is an optical storage medium comprising at least one layer that has a pattern of features in at least one major surface, at least one reflective film layer or coating is adjacent to at least one layer that has a pattern of features in at least one major surface; at least one reflective film layer or coating includes a metal alloy. The metal alloy of at least one reflective film layer or coating includes copper, zinc and magnesium; the relationship between the amounts of copper, zinc, and magnesium in the metal alloy is defined by CuₓZn_{y}Mg_{z}, where 0.85<x<0.9998, 0.0001<u<0.10, and 0.0001<z<0.05. In another embodiment, the copper, zinc and magnesium metal alloy further includes between 0.1 and 5.0 a/0 percent nickel.

Another embodiment is an optical storage medium comprising at least one layer that has a pattern of features in at least one major surface; at least one reflective film layer or coating is adjacent to at least one layer that has a pattern of features in at least one major surface; at least one reflective film layer or coating includes a metal alloy. The metal alloy of at least one reflective film layer or coating includes copper, silver and nickel; the relationship between the amounts of copper, silver and nickel in the metal alloy is defined by CuₓAg_{y}Niᵥ, where 0.85<x<0.9998, 0.0001<y<0.05 and 0.0001<v<0.10. In another embodiment the copper, silver, nickel metal alloy further includes between 0.1 and 5.0 a/0 percent zinc.

In another embodiment a copper, silver, nickel alloy including between about 5.0 a/o percent and about 0.01 a/o percent silver; between about 10.0 a/o percent and about 0.01 a/o percent nickel and the rest copper for use in the reflective coating of an optical storage device further includes at least one additional element in the amount of between about 5.0 a/o percent and about 0.01 a/o percent of the additional element; additional elements suitable for addition to the copper silver, nickel alloy include cobalt, boron, aluminum, indium and mixtures thereof.

Still another embodiment is an optical storage medium comprising at least one layer that has a pattern of features in at least one major surface; at least one reflective film layer or coating is adjacent to at least one layer that has a pattern of features in at least one major surface; at least one reflective film layer or coating includes a metal alloy. The metal alloy of at least one reflective film layer or coating includes copper, silver and nickel; the relationship between the amounts of copper, and nickel, wherein the relationship between the amounts of copper and nickel in said metal alloy is defined by CuₓNiᵥ, where 0.80<x<0.9999, 0.0001<v<0.20. In yet another embodiment the amount of nickel in the copper nickel alloy is defined by CuₓNiᵥ where 0.0001<v<0.01.

Another embodiment is an optical storage medium comprising at least one layer that has a pattern of features in at least one major surface; at least one reflective film layer or coating is adjacent to at least one layer that has a pattern of features in at least one major surface; at least one reflective layer or coating includes a metal alloy. The metal alloy of at least one reflective film layer or coating includes copper, and zinc, where the relationship between the amounts of copper and zinc in said metal alloy is defined by CuₓZnᵤ, where 0.90<x<0.9999, 0.0001<u<0.10.

In another embodiment a copper, zinc alloy including between about 0.01 a/o percent and about 0.10 a/o zinc; and the rest copper for use in the reflective coating of an optical storage device further includes at least one additional element in the amount of between about 5.0 a/o percent and about 0.01 a/o percent of the additional element; additional elements suitable for addition to the copper silver, nickel alloy include cobalt, boron, aluminum, indium and mixtures thereof.

### BRIEF DESCRIPTION OF THE DRAWINGS

FIG. 1 is an optical storage system according to one embodiment of this invention.

FIG. 2 is an optical storage system according to another embodiment of this invention where an organic dye is used as a recording layer.

FIG. 3 is an optical storage system according to another embodiment of this invention with two layers of information pits where the playback of both layers is from one side.

FIG. 4 is an optical storage system according to another embodiment of this invention with three layers of information pits where the playback of all three layers is from one side.

FIG. 5 is an optical storage system according to another embodiment of this invention where the system contains a rewritable information layer.

FIG. 6 another embodiment is a rewritable optical information system.

FIG. 7 is an optical storage system according to still another embodiment of the invention including two readable and recordable dye layers readable and recordable from one side.

FIG. 8 is an optical storage system according to another embodiment of this invention the for example an optical data storage device sometimes referred to as a DVD-14.

FIG. 9 is an optical storage system according to another embodiment of this invention the for example an optical data storage device sometimes referred to as a DVD-18.

### DESCRIPTION OF THE PREFERRED EMBODIMENTS

Specific language is used in the following description and examples to publicly disclose the invention and to convey its principles to others. No limits on the breadth of the patent rights based simply on using specific language are intended. Also included are any alterations and modifications to the descriptions that should normally occur to one of average skill in this technology.

As used in this specification the term “atomic percent” or “a/o percent” refers to the ratio of atoms of a particular element or group of elements to the total number of atoms that are identified to be present in a particular alloy. For example, an alloy that is 15 atomic percent element “A” and 85 atomic percent element “B” could also be referenced by a formula for that particular alloy: A_{0.15}B_{0.85}.

As used herein the term “of the amount of copper present” is used to describe the amount of a particular additive that is included in the alloy. Used in this fashion, the term means that the amount of copper present, without consideration of the additive, is reduced by the amount of the additive that is present to account for the presence of the additive in a ratio. For example, if the relationship between Cu and an element “X” is Cu_{0.85} X_{0.15} (respectively 85 a/o percent and 15 a/o percent) without the considering the amount of the additive that is present, and if an additive “B” is present at a level 5 atomic percent “of the amount of copper present”; then the relationship between Cu, X, and B is found by subtracting 5 atomic percent from the atomic percent of copper, or the relationship between Cu, X, and B is Cu_{0.80} X_{0.15} B_{0.05} (respectively 80 a/o percent copper, 15 a/o percent “X”, and 5 a/o percent “B”).

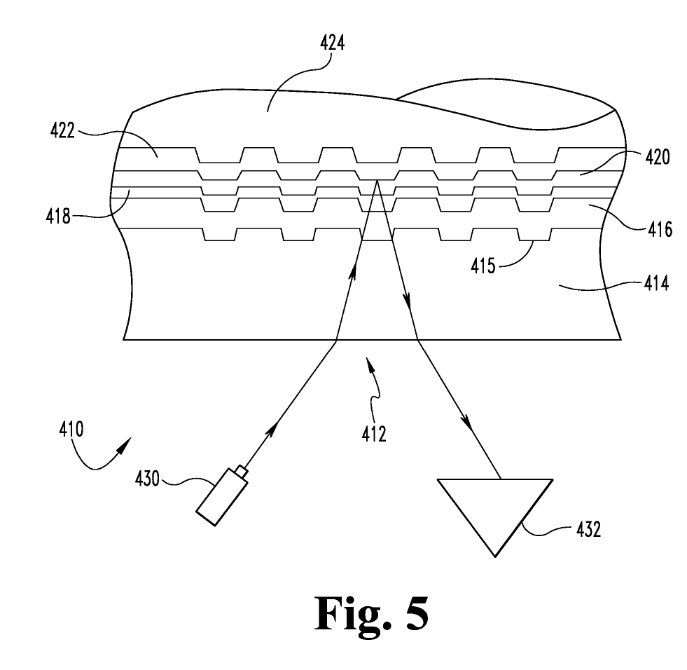

As used in this specification the term “adjacent” refers to a spatial relationship and means “nearby” or “not distant.” Accordingly, the term “adjacent” as used in this specification does not require that items so identified are in contact with one another and that they may be separated by other structures. For example, referring to FIG. 5, layer 424 is “adjacent” or “nearby” layer 422, just as layer 414 is “adjacent” or “nearby” layer 422.

Metal alloys for use in optical recording devices have been disclosed in U.S. Pat. Nos. 6,007,889, 6,280,811, 6,451,402 B1, 6,764,735, 6,790,503, 6,544,616 B2, 6,852,384, 5,896,947B2, 6,841,219, 6,905,750B2, 7,045,187, 7,045,188, and 7,018,696 all of which are hereby incorporated by reference in their entirety as if each were incorporated separately in its entirety.

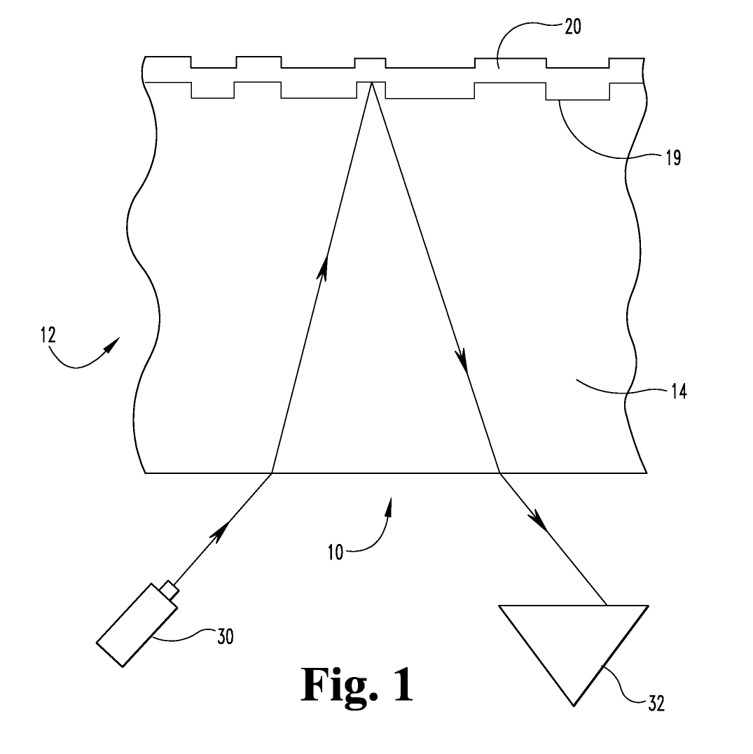

This invention comprises multi-layer metal/substrate compositions that are used as optical data storage media. One embodiment of this invention is shown in FIG. 1 as optical data storage system 10. Optical storage medium 12 comprises a transparent substrate 14, and a highly reflective thin film layer or coating 20 on a first data pit pattern 19. An optical laser 30 emits an optical beam toward medium 12, as shown in FIG. 1. Light from the optical beam that is reflected by thin film layer 20 is sensed by detector 32, which senses modulations in light intensity based on the presence or absence of a pit or land in a particular spot on the thin film layer. The disc is unique in that one of the alloys presented below is deposited upon the information pits and lands and is used as the highly reflective thin film 20. In one alternative (not shown), the disc may be varied by attaching two optical storage media 12 back-to-back, that is, with each transparent substrate 14 facing outward.

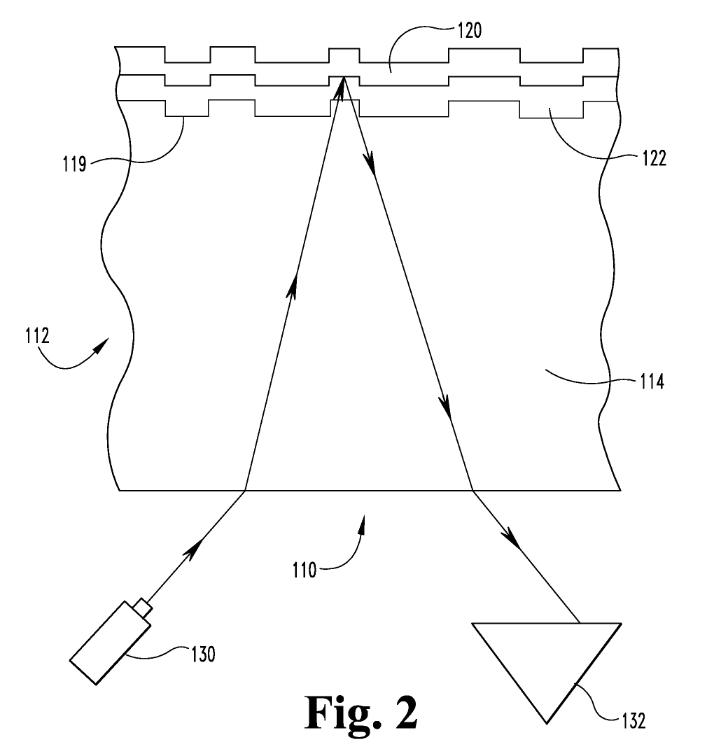

Another embodiment of this invention is shown in FIG. 2 as optical data storage system 110. Optical storage medium 112 comprises a transparent substrate 114, and a highly reflective thin film layer 120, over a layer of dye 122, placed over a first pattern 119. An optical laser 130 emits an optical beam toward medium 112, as shown in FIG. 2. As discussed earlier, data is placed upon the disc by deforming portions of the dye layer with a laser. Thereafter, the disc is played by light from the optical beam, which is reflected by thin film layer 120 and sensed by detector 132. Detector 132 senses modulations in light intensity based on the presence or absence of a deformation in the dye layer. The disc is unique in that one of the alloys presented below is deposited over the dye layer 122 and is used as the highly reflective thin film or coating 120. In one alternative (not shown), the disc may be varied by attaching two optical storage media 112 back-to-back, that is, with each transparent substrate 114 facing outward.

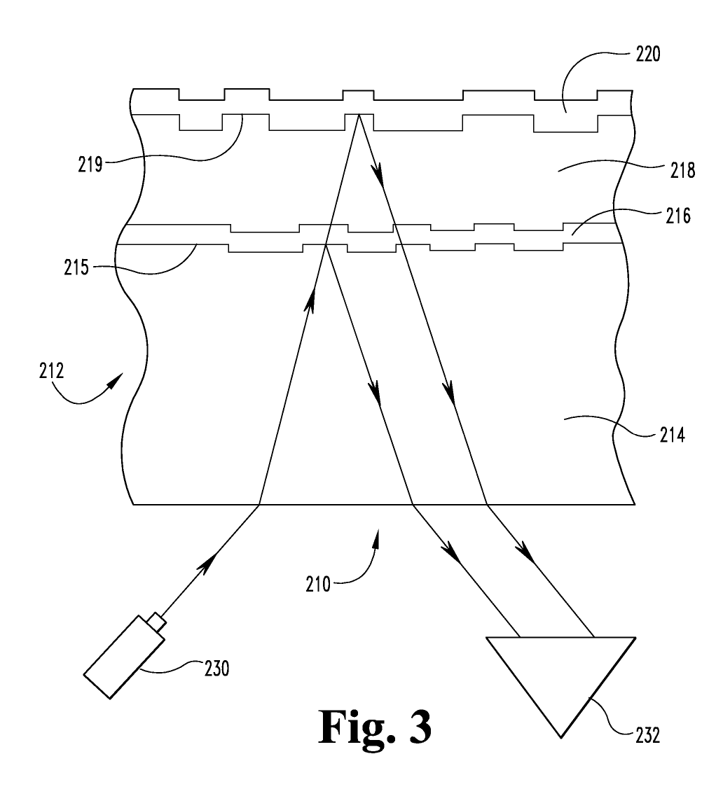

Another embodiment of this invention is shown in FIG. 3 as optical data storage system 210. Optical storage medium 212 comprises a transparent substrate 214, a partially reflective thin film layer or coating 216 on a first data pit pattern 215, a transparent spacer layer 218, and a highly reflective thin film layer or coating 220 on a second data pit pattern 219. An optical laser 230 emits an optical beam toward medium 212, as shown in FIG. 3. Light from the optical beam that is reflected by either thin film layer 216 or 220 is sensed by detector 232, which senses modulations in light intensity based on the presence or absence of a pit in a particular spot on the thin film layers. The disc is unique in that one of the alloys presented below is deposited upon the information pits and lands and used as the highly reflective thin film 220 or semi-reflective layer 216. In another alternative (not shown), the disc may be varied by attaching two optical storage media 212 back-to-back, that is, with each transparent substrate 214 facing outward. The attachment method could be by UV cured adhesive, hot melt adhesive or other type of adhesives.

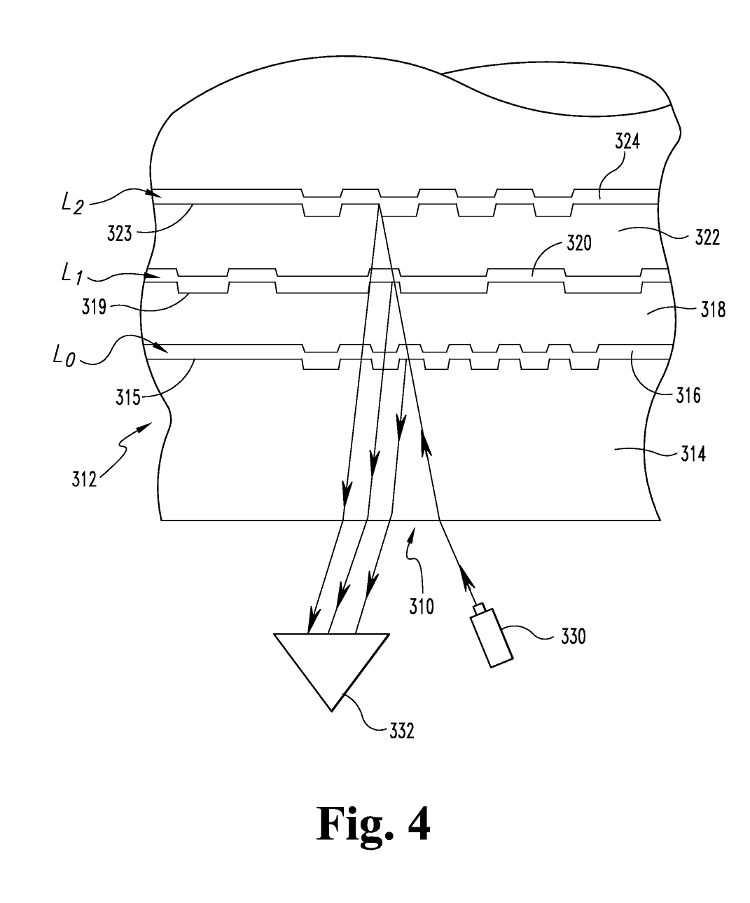

Another embodiment of this invention is shown in FIG. 4 as optical data storage system 310. Optical storage medium 312 comprises a transparent substrate 314, a partially reflective thin film layer or coating 316 or layer “zero” on a first data pit pattern 315, a transparent spacer layer 318, another partially reflective thin film layer or coating 320 or layer “one” on a second data pit pattern 319, a second transparent spacer layer 322, and a highly reflective thin film layer or coating 324 or layer “two” on a third pit pattern 323. An optical laser 330 emits an optical beam toward medium 312, as shown in FIG. 4. Light from the optical beam that is reflected by thin film layer 316, 320 or 324 is detected by detector 332, which senses modulation in light intensity based on the presence or absence of a pit in a particular spot on the thin film layers. The disc is unique in that any or all of the alloys presented below can be deposited upon the information pits and lands and used as the highly reflective thin film or coating 324 or the semi-reflective layer or coating 316 and 320. To playback the information on Layer 2, the light beam from laser diode 330 is going through the transparent polycarbonate substrate, passing through the first semi-reflective Layer 0, and the second semi-reflective Layer 1 and then reflected back from layer 2 to the detector 332. In another alternative (not shown), the disc may be varied by attaching two optical storage media 312 back-to-back, that is, with each transparent substrate 314 facing outward. The attachment method could be by UV cured adhesive, hot melt adhesive or other type of adhesives.

Still another embodiment of this invention is shown in FIG. 5 as optical data storage system 410. Optical storage medium 412 comprises a transparent substrate, a dielectric layer 416 on a first data pit pattern 415, a recording layer 418 made of a material having a microstructure including domains or portions capable of repeatedly undergoing laser-induced transitions from a first state to a second state and back again (i.e., an optically re-recordable or rewritable layer), such as a phase change material or a magneto-optic material, another dielectric material 420, a highly reflective thin film layer 422, and a transparent substrate or layer 424. As used in this specification, a dielectric material is a material that is an electrical insulator or in which an electric field can be sustained with a minimum dissipation of power. The different layers 414, 416, 418, 420 and 422 of the optical storage medium 410 are preferably oriented so as to be adjacent with one another.

The optical recordable material may be for example, a magneto-optic material selected from the group consisting of Tb—Fe—Co and Gd—Tb—Fe.

Commonly used phase change materials for the recording layer 418 include germanium-antimony-tellurium (Ge—Sb—Te), silver-indium-antimony-tellurium (Ag—In—Sb—Te), chromium-germanium-antimony-tellurium (Cr—Ge—Sb—Te) and the like. Commonly used materials for the dielectric Layer 416 or 420 include zinc sulfide-silica compound (ZnS.SiO₂), silicon nitride (SiN), aluminum nitride (AlN) and the like. Commonly used magneto-optic materials for the recording layer 418 include terbium-iron-cobalt (Tb—Fe—Co) or gadolinium-terbium-iron (Gd—Tb—Fe). An optical laser 430 emits an optical beam toward medium 412, as shown in FIG. 5. In the recording mode for the phase change recordable optical medium, light from the optical beam is modulated or turned on and off according to the input digital data and focused on the recording layer 418 with suitable objective while the medium is rotated in a suitable speed to effect microstructural or phase change in the recording layer. In the playback mode, the light from the optical beam that is reflected by the thin film layer 422 through the medium 412 is sensed by the detector 432, which senses modulations in light intensity based on the crystalline or amorphous state of a particular spot in the recording layers. The disc is unique in that one of the alloys presented below is deposited upon the medium and used as the highly reflective thin film 422. In another alternative (not shown), the disc may be varied by attaching two optical storage media 412 back-to-back, that is, with each transparent substrate or coating 414 facing outward. The attachment method could be by UV cured adhesive, hot melt adhesive or other type of adhesives.

As illustrated in FIG. 5, if transparent substrate 414 is about 1.2 mm thick and made of injection molded polycarbonate which includes continuous spirals of grooves and lands, 424 is a UV cured acrylic resin 3 to 15 micron thick acting as a protective layer with the playback laser 430 at 780 to 820 nanometer, and rewritable layer 418 is a phase change material of a typical composition such as Ag—In—Sb—Te, this type of compact disc-rewritable disc structure is sometimes referred to as a CD-RW. To record and read information, phase change discs utilize the recording layer's ability to change from an amorphous phase with low reflectivity (dark) to a crystalline phase with high reflectivity (bright). Before recording, the phase change layer is in a crystalline state. During recording, a laser beam with high power focused on the recording layer will heat the phase change material to high temperature and when the laser is turned off, the heated spot will cool off very quickly to create an amorphous state. Thus a series of dark spots of amorphous states are created according to the input data of turning the focused laser beam on and off. These on and off correspond to “0” and “1” of a digital data stream.

In reading, a low laser power is used to focus on and read the dark or bright spots along the track of the disc to play back the recorded information. To erase, an intermediate laser power is used to focus on the grooves or tracks with the disc spinning so that an intermediate temperature of the focused spots is reached. After the laser is moved to another location, the spots cool to room temperature forming a crystalline structure of high reflectivity. This returns the recording layer to its original or erased state. The change of the spots' state from amorphous to crystalline is very reversible, thus many record and erase cycles can be accomplished and different data can be repeatedly recorded and read back without difficulty.

If transparent substrate 414 is about 0.5 to 0.6 mm thick made of injection molded polycarbonate with continuous spirals of grooves and lands, 416 and 420 are dielectric layers typically made of ZnS.SiO₂, 418 is made of a phase change material such as Ag—In—Sb—Te or Ge—Sb—Te, 422 is made of a metal alloy of the current invention, and 424 is a UV cured resin bonding another half of the same structure as depicted in FIG. 5., and the structure is used with a read and write laser 430 at 630 to 650 nanometer wavelength, then it is a digital versatile disc with rewritable capability, commonly referred to as DVD+RW. Some preferred phase-changeable materials include materials from the following series: As—Te—Ge, As—In—Sb—Te, Te—Ge—Sn, Te—Ge—Sn—O, Bi—Ge, Bi—Ge—Sb, Bi—Ge—Te, Te—Se, Sn—Te—Se, Te—Ge—Sn—Au, Ge—Sb—Te, Sb—Te—Se, In—Se—Tl, In—Sb, In—Sb—Se, In—Se—Tl—Co, Cr—Ge—Sb—Te and Si—Te—Sn, where As is arsenic, Bi is Bismuth, Te is tellurium, Ge is germanium, Sn is tin, O is oxygen, Se is selenium, Au is gold, Sb is antimony, In is indium, Tl is thallium, Co is cobalt, and Cr is chromium. In this disc configuration, highly reflective layer 422 must have high reflectivity at 650 nanometer wavelength, high thermal conductivity, and high corrosion resistance in the presence of ZnS.SiO₂ Conventional aluminum alloy are not reflective enough, nor do they have high enough thermal conductivity. Pure silver and many silver alloys have corrosion resistance, reflectivity, and thermal conductivity values that are too low for use in these devices. Thus it is another objective to provide a series of copper alloys that can meet the requirements for these devices.

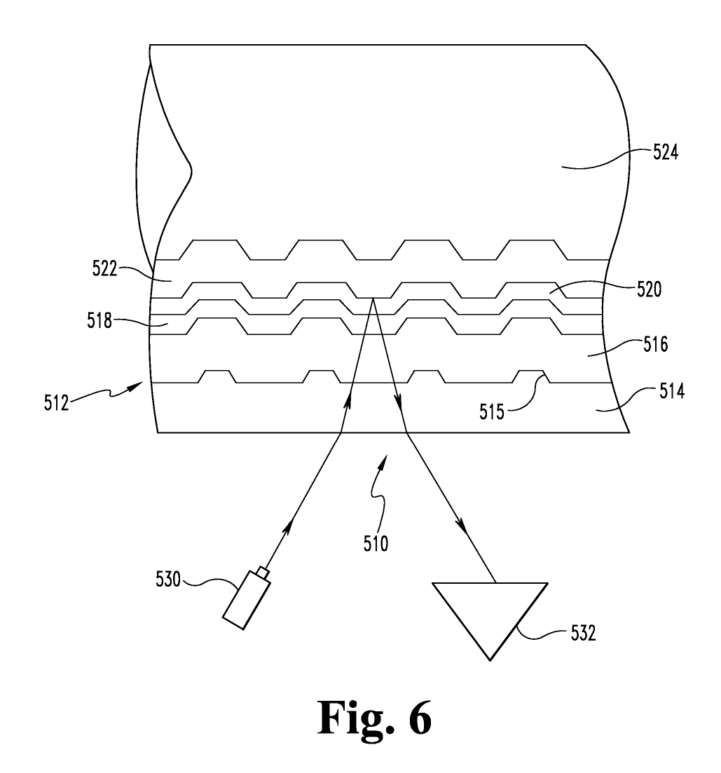

Referring now to FIG. 6, illustrated herein is another embodiment a rewritable type optical information storage system 510. Transparent cover layer 514 is about 0.1 mm thick. Dielectric layers 516 and 520 are typically made of ZnS.SiO₂ and serve as protective layers for the rewritable layer or phase change layer 518. Rewritable layer 518 is preferably formed from Ag—In—Sb—Te or the like. Highly reflective layer 522 is made of a metal alloy of the current invention. Transparent substrate 524 is preferably about 1.1 mm thick with continuous tracks and groves and typically made of a polycarbonate substrate. If laser 530 is operated with associated optics to focus and receive the optic beam as well as a suitable detector and circuitry to decode the information included in the reading beam system 510 it is sometimes referred to as a “Digital Video Recording System” or DVR. If laser 530 is operated at 400 nm the device is similar to a CD-RW disc except that the recording density is considerably higher.

Some preferred phase-changeable materials include materials from the following series: As—Te—Ge, As—In—Sb—Te, Te—Ge—Sn, Te—Ge—Sn—O, Bi—Ge, Bi—Ge—Sb, Bi—Ge—Te, Te—Se, Sn—Te—Se, Te—Ge—Sn—Au, Ge—Sb—Te, Sb—Te—Se, In—Se—Tl, In—Sb, In—Sb—Se, In—Se—Tl—Co, Cr—Ge—Sb—Te and Si—Te—Sn, where As is arsenic, Bi is Bismuth, Te is tellurium, Ge is germanium, Sn is tin, O is oxygen, Se is selenium, Au is gold, Sb is antimony, In is indium, Tl is thallium, Co is cobalt, and Cr is chromium. In this disc configuration, highly reflective layer 522 must have high reflectivity at 650 nanometer wavelength, high thermal conductivity, and high corrosion resistance in the presence of ZnS.SiO₂ Conventional aluminum alloy are not reflective enough, nor do they have high enough thermal conductivity. Pure silver and many silver alloys have corrosion resistance, reflectivity, and thermal conductivity values that are too low for use in these devices. Thus it is another objective to provide a series of copper alloys that can meet the requirements for these devices.

Other optical recording media which can be used to practice this invention include for example optical storage devices readable and in some embodiments also rewritable from both sides of the device.

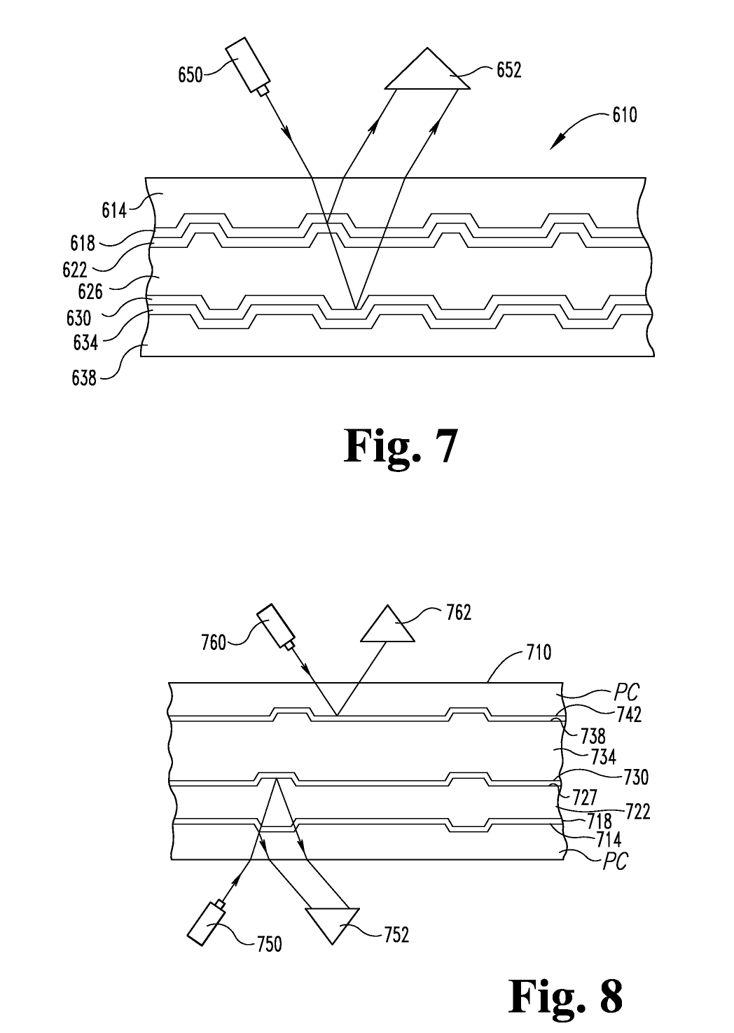

In another embodiment, illustrated in FIG. 7, an optical storage device 610 of the organic dye recordable-dual-layer type comprises two layers which are both readable and recordable from the same side of the device. Device 610 comprises substrate layer 614 adjacent to first recordable dye layer 618. Dye layer 618 is adjacent to semi-reflective layer or coating 622. Layer or coating 622 is adjacent to spacer layer 626. Spacer layer 626 is adjacent to a second dye recording layer 630. Layer 630 is adjacent to highly reflective layer or coating 634. Reflective layer or coating 634 is adjacent to polycarbonate substrate or layer 638.

In write mode, as illustrated in FIG. 7, optical beam source 650 emits an optical beam which passes through layers 614, and is focused on dye layer 618. When laser 650 is operating at high intensity the optical beam focused on layer 618 decomposes the dye in layer 618 creating a data pit pattern comprising the equivalent of a series of pits and lands. A portion of an optical beam emitted by laser 650 passes through layers 614, 618, 622, 626 and is focused on dye layer 630. When laser 650 is operating at high intensity the optical beam focused on layer 630 decomposes the dye in layer 630 to create a data pit pattern comprising a series of pits and lands.

In read mode a portion of an optical beam emitted by laser 650 passes through transparent polycarbonate layer 614 and dye layer 618, is reflected by semi-reflective layer or coating 622 is sensed by detector 652. A portion of the optical beam also passes through layers 614, 618, 622, 626, 630 and is reflected by highly reflective layer 1234 and sensed by detector 652. Detector 652 senses modulations in light intensity based on the presence or absence of a pit or land in a particular spot on the highly reflective layer or coating 634 or by the semi-reflective layer or coating 622 depending on whether the laser light 650 is focused on the semi-reflective layer 622 or the highly reflective layer 634. For the general operation of an organic dye-based optical recording medium, the reader can refer to U.S. Pat. Nos. 6,641,889, and 6,551,682 both of which are herein incorporated by reference in their entireties.

It is further understood that the optical disc structure as described in FIG. 7 can be at least a portion of a dual layer DVD-R disc wherein the playback laser beam has a wavelength of around 635 to 650 nm, or the structure can be a least a portion of a dual layer HD-DVD-R disc wherein the playback laser has a wavelength around 400 nm or any other optical disc structure wherein two or more layers of information can all be recorder or played back from one side of the disc in which a semi-reflective layer or highly reflective layers of metal alloy as disclosed in this invention is made useful.

One embodiment is illustrated in FIG. 8, optical data storage system 710. Optical storage system 710 is sometimes referred to as DVD-14 and is illustrative of devices that have the capacity to store accessible data on both sides of the structure.

Optical storage system 710 comprises a 0.6 mm thick transparent polycarbonate substrate (PC), adjacent to the PC layer or a part of the PC layer is a first data pit pattern 714 comprising a series of pits and lands. Adjacent to layer 714 and conforming to the contour of layer 714 is a semi-reflective layer or coating 718. Adjacent to the layer or coating 718 is a spacer 722 comprised of a transparent material adjacent to or a part of spacer layer 722 is a second data pit pattern 726 comprising a series of pits and lands. Adjacent to and conforming to the contour of second data pit pattern 726 is a reflective layer or coating 730. Both semi-reflective layer or coating 718 and highly reflective layers 730 can be read from the same side of structure 710.

Adjacent to layer or coating 734 is a second reflective layer or coating 738. Layer or coating 738 is adjacent to and conforms to the contours of a third data pit pattern 742 comprising a series of pits and lands. Third data pit pattern 742 and highly reflective layer or coating 738 are readable from the side of the device opposite to the side of the device from which data pit patterns 718, 726 are read. Adjacent to or comprising data pit pattern 742 is a second 0.6 mm thick polycarbonate layer.

An optical laser 760 emits an optical beam towards second polycarbonate layer PC, the beam is reflected by highly reflective layer or coating 738 and sensed by detector 762 modulations in light intensity based on the presence or absence of a pit in a particular spot on the highly reflective coating or layer.

As illustrated in FIG. 8, from the side of device 710 opposite of laser 760, a second optical beam from laser 750 is directed towards first polycarbonate substrate layer PC towards data pit pattern 714. As illustrated in FIG. 8, the second laser 750 emits an optical beam towards semi-reflective layer or coating 718 and highly reflective layer 730. At least a portion of the optical beam emitted by laser 750 passes through semi-reflective layer 718 to reach reflective layer 726. Light from the optical beam that is reflected by layer or coating 726 is sensed by detector 752, which senses modulations in light intensity based on the presence or absence of a pit or land in a particular spot on the highly reflective layer.

While the optical storage device illustrated in FIG. 8 comprises multiple laser sources 750, 760 and multiple detectors 752, 762, the same could be accomplished using a single laser source and detector configured such that the same optical beam source and detector can be used to collect signal from all sets of information pits and lands comprising the device, for example set 718, 726, 742.

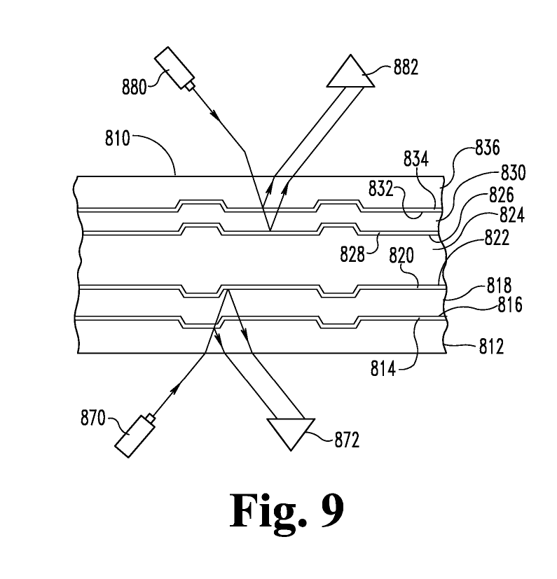

In still another embodiment the invention may be practiced using the optical storage system 810 as illustrated in FIG. 9. Optical data storage medium 810 is illustrative of an optical data storage device such as a DVD-18 and is representative of optical storage systems that have multiple information layers readable from both sides of the optical storage medium.

Optical storage system 810 comprises a 0.6 mm thick transparent substrate 812 adjacent to, or comprising a first data pit pattern 814. Data pit pattern 814 comprises a series of pits and lands and is adjacent to a semi-reflective layer or coating 816. The device further includes a transparent spacer layer 818 about 50 microns thick, and a second data pit pattern 820 adjacent to a highly reflective film or coating 822. Both semi-reflective layer or coating 816 and highly reflective layer or coating 822 can be read from the same side of 810.

An optical laser 870 emits an optical beam towards transparent layer 812. As illustrated in FIG. 9 at least a portion of the optical beam emitted by laser source 870 passes through semi-reflective layer 816 to reach highly reflective layer 822. Light from the optical beam that is reflected by semi-reflective layer or coating 816 and highly reflective layer 822 is sensed by detector 872, which senses modulations in light intensity based on the presence or absence of a pit or land in a particular spot on the highly reflective layer or the semi-reflective layer.

The optical storage device illustrated in FIG. 9 further includes the spacer layer 824, which connects the portion of the device comprising the first two information layers 814, 820 with the portion of the device comprising the third and forth information layers 828, 834. Substrate layer 824 is adjacent to and separates highly reflective layer or coating 828 and highly reflective layer or coating 822.

Highly reflective layer or coating 824 is adjacent to, and conforms to the contours of the pit and lands or data pit pattern layer 828. Layer 828 is adjacent to spacer layer 826, spacer layer 826 is adjacent to semi-reflective layer 832, which is adjacent to, and conforms to the contours of data pit pattern layer 834. Data pit pattern layer 834 is contiguous with, or adjacent to, 0.6 mm thick substrate layer 836.

In the embodiment illustrated in FIG. 9 an optional second optical laser 880 is provided which emits an optical beam towards layer 836. A portion of the light emitted by laser 880 passes through semi-reflective layer or coating 832 and is reflected by highly reflective layer or coating 824 light reflected by semi-reflective layer or coating 832 and highly reflective layer 824 is sensed by detector 882, which senses modulations in light intensity based on the presence or absence of a pit or land in a particular spot on the highly reflective layer.

While the optical storage device illustrated in FIG. 9 includes multiple laser sources 870, 880 and multiple detectors 852, 872, the same could be accomplished using a single laser source and detector configured such that the same optical beam source and detector can be used to collect signal from all sets of information pits and lands comprising the device.

As used herein, the term “reflectivity” refers to the fraction of optical power incident upon transparent substrate 14, 114, 214, 314, 414, 514, 614, 812, 836 or PC and analogous substrates described herein which, when focused to a spot on a region of layer 20, 120, 216, 220, 316, 320, 324, 422, 522 618, 630, 724, 730, 718, 834, 828, 814, 820 and analogous layers and coating described herein could in principle, be sensed by a photodetector in an optical readout device. It is assumed that the readout device includes a laser, an appropriately designed optical path, and a photodetector, or the functional equivalents thereof.

One aspect is based on the ability of copper-based alloys to provide sufficient reflectivity and corrosion resistance to be used as the reflective layer in an optical storage medium, without the inherent cost of a material that is at least substantially comprised of gold and/or silver.

In one embodiment, copper is alloyed with comparatively small amounts of silver and magnesium. In this embodiment, the relationship between the amounts of copper, silver and magnesium ranges from about 0.01 a/o percent (atomic percent) to about 5.0 a/o percent silver, 0.01 a/o percent (atomic percent) to about 5.0 a/o percent magnesium and from about 90 a/o percent to about 99.98 a/o percent copper. In another embodiment the copper, silver, magnesium alloy further includes between about 0.01 a/o percent (atomic percent) to about 10.0 a/o percent zinc.

In another embodiment, copper is alloyed with comparatively small amounts of silver and zinc. In this embodiment, the relationship between the amounts of copper, silver and zinc ranges from about 0.01 a/o percent (atomic percent) to about 5.0 a/o percent silver, 0.01 a/o percent (atomic percent) to about 10.0 a/o percent zinc and from about 85 a/o percent to about 99.98 a/o percent copper. In another embodiment, a copper based zinc and silver alloy includes between about 0.1 a/o percent to about 5.0 a/o percent nickel.

In yet another embodiment, copper is alloyed with comparatively small amounts of magnesium and nickel. In this embodiment, the relationship between the amounts of copper, magnesium and nickel ranges from about 0.01 a/o percent (atomic percent) to about 5.0 a/o percent magnesium, 0.01 a/o percent (atomic percent) to about 10.0 a/o percent nickel and from about 85 a/o percent to about 99.98 a/o percent copper.

In still another embodiment, copper is alloyed with comparatively small amounts of zinc and magnesium. In this embodiment, the relationship between the amounts of copper, zinc and magnesium ranges from about 0.01 a/o percent (atomic percent) to about 10.0 a/o percent zinc, 0.01 a/o percent (atomic percent) to about 5.0 a/o percent magnesium and from about 85 a/o percent to about 99.98 a/o percent copper. In another embodiment, a copper based zinc and magnesium alloy includes between about 0.1 a/o percent to about 5.0 a/o percent nickel.

In one embodiment, copper is alloyed with comparatively small amounts of both silver and nickel. In this embodiment, the relationship between the amounts of copper, silver and nickel ranges from about 0.01 a/o percent (atomic percent) to about 5.0 a/o percent silver, 0.01 a/o percent (atomic percent) to about 10.0 a/o percent nickel and from about 85 a/o percent to about 99.98 a/o percent copper. In still another embodiment the copper, silver, nickel alloy may further include between 0.1 and 5.0 a/o percent zinc.

In one embodiment, copper is alloyed with a comparatively small amount of nickel. In this embodiment, the relationship between the amount of copper and nickel ranges from about 0.01 a/o percent (atomic percent) to about 10.0 a/o percent nickel and from about 90 a/o percent to about 99.99 a/o percent copper.

In still another embodiment, copper is alloyed with a comparatively small amount of zinc. In this embodiment, the relationship between the amount of copper and zinc ranges from about 0.01 a/o percent (atomic percent) to about 10.0 a/o percent zinc and from about 90 a/o percent to about 99.99 a/o percent copper.

In yet another embodiment copper is alloyed with a comparatively small amount of nickel. In this embodiment, the relationship between the amount of copper and nickel ranges from about 0.01 a/o percent (atomic percent) to about 20.0 a/o percent nickel and from about 80 a/o percent to about 99.99 a/o percent copper.

For the convenience of the reader, the following are some copper alloys, where the alloying elements, that may preferably be alloyed with copper are identified by their periodic table symbols; Ag+Mg, or Ag+Mg+Zn, or Mg+Ni, or Mg+Ni+Zn, or Ag+Ni, or Ag+Zn+Ni, or Zn, or Ni, or Zn+Co, or Zn+B, or Zn+Al, or Zn+In, or Ag+Ni+Co, or Ag+Ni+B, or Ag+Ni+Al, or Ag+Ni+In.

Having presented the preceding compositions for the thin film materials, it is important to recognize that both the manufacturing process of the sputtering target and the process to deposit the target material into a reflective layer, coating or film play important roles in determining the final properties of the film. To this end, a preferred method of making the sputtering target will now be described. In general, vacuum melting and casting of the alloys or melting and casting under protective atmosphere, are preferred to minimize the introduction of other unwanted impurities.

Afterwards, the as-cast ingot should undergo a cold or hot working process to break down the segregated and the non-uniform as-cast microstructure. One preferred method is cold or hot forging or cold or hot uniaxial compression with a more than 50 percent of size reduction, followed by annealing to recrystallize the deformed material into fine equi-axed grain structure with preferred texture of <1,1,0> orientation. This texture promotes directional sputtering in a sputtering apparatus so that more of the atoms from the sputtering target will be deposited onto the disc substrates for more efficient use of the target material.

Alternatively, a cold or hot multi-directional rolling process with more than a 50 percent size reduction can be employed, followed by annealing, to promote a random oriented microstructure in the target followed by machining the target to a final shape and size suitable for a given sputtering apparatus. A target, with a more random crystal orientation, will ejection atoms more randomly during sputtering, and will produce a disc substrate with a more uniform distribution and thickness.

Depending on the application, different discs' optical and other system requirements, either a cold or hot forging or a cold or hot multi-directional rolling process can be employed in the target manufacturing process to optimize, the optical and other performance requirements of, the thin film for use in a given application.

The alloys of this invention can be deposited using the well-known methods described earlier including, for example sputtering, thermal evaporation or physical vapor deposition, and possibly electrolytic or electroless plating processes. The alloy layer's reflectivity can vary depending on the method of application. Any application method that adds impurities to, or changes the surface morphology of, the thin film layer on the disc could conceivably, lower the reflectivity of the layer. But to a first order of approximation, the reflectivity of the film layer on the optical disc is primarily determined by the starting material of the sputtering target, evaporation source material, or the purity and composition of the electrolytic and electroless plating chemicals used.

It should be understood that the reflective layer of this invention can be used for future generations of optical discs that use a reading laser of a shorter wavelength, for example, a reading laser with a wavelength of 650 nanometers or shorter.

### EXAMPLES

### Example 1

A copper based alloy with about 1.2 atomic percent zinc and approximately 1.0 atomic percent silver, at a thickness of about 50-60 nanometers, will have a reflectivity of approximately 94 to 95 percent at a wavelength of 800 nanometers and a reflectivity of approximately 93 to 94 percent at a wavelength of 650 nanometers.

### Example 2

A copper-rich alloy with about 1 a/o percent silver and about 2 a/o percent of magnesium, and about 97 a/o percent copper is deposited by sputtering on a surface of a CD-R adjacent to a cyano-dye recording surface from an copper, silver magnesium alloy target by supporting to thick of between 50 and 60 namometers. The cyanine dye layer includes a pattern of feature in the form of a wobble groove. The disc has a reflectivity at 600 nm in the range of suitable for use in the commercial CD-R optical data storage devices.

The CD-R was subjected to an accelerated aging test. The disc was held at 70 degrees C. and 50% RH for 40 days. Afterwards, the reflectivity and the electronic signals were measured again and no significant changes were observed as compared to the same measurements before aging test.

### Example 3

A copper based alloy with about 1.0 a/0 percent magnesium, about 5.0 a/o percent of nickel and about a/o percent of zinc, about 60-70 nanometers thick, will have a reflectivity of approximately 95 percent at a wavelength of about 650 nanometers. It is suitable for any high reflectivity application in an optical information storage medium.

### Example 4

A copper based alloy sputtering target with a composition of about 1.0 a/o percent silver, about 5.0 a/o percent nickel, about 1 a/0 percent zinc and the balance substantially copper is employed to produce the layer of a DVD-R dual layer disc using the following procedure. On top of another transparent polycarbonate half disc approximately 0.6 millimeter thick with information pits injection molded from a suitable stamper, a high reflectivity thin film or layer “one” of a copper based alloy based alloy approximately 55 nanometers thick is deposited using a suitable copper, silver, nickel, zinc sputtering target in a sputtering machine. These two half discs are then separately spin-coated with suitable liquid organic resins, bonded together with layer “zero” and layer “one” facing each other and the resin is cured with ultraviolet light. The distance within the disc between the layers “zero” and the layer “one” is kept at about 55+/−5 microns.

The reflectivity of the two information layers is measured from the same side of the disc and found to be about the same 21 percent using a 650 nanometers wavelength laser light. Electronic signals such as jitter and PI error are measured and found to be within published DVD specifications. Subsequently, an accelerated aging test at 70 degrees C. and 50 percent relative humidity for 40 days is conducted on the disc. Afterwards, the reflectivity and the electronic signals are measured again and no significant changes are observed as compared to the same measurements made before the aging test.

### Example 5

A copper based alloy sputtering target with the composition in atomic percent of about 5.0 percent nickel, and the balance substantially copper is employed to produce the reflective layer of a DVD-9 dual layer disc. The procedure used to make the discs is the same as the procedure used in the aforementioned example 4. The reflectivity of the two information layers in the finished disc is measured from the same side of the disc and found to be about the same, about 22.5 percent using a 650 nanometers wavelength laser light. Electronic signals such as jitter and PI error are also measured and found to be within published DVD specifications. Subsequently, an accelerated aging test at 70 degrees C. and 50 percent relative humidity for 96 hours is conducted on the disc. Afterwards, the reflectivity and the electronic signals are measured again and no significant changes are observed compared to the same measurements made before the aging test.

### Example 6

A copper based alloy sputtering target with a composition in a/o % of approximately 1.0% silver, 1.0% zinc, and the balance copper is used to produce the reflective layer of another type of recordable disc a DVD-R disc or a DVD+R disc using the following procedure. Referring now to FIG. 2. A cyanine based recording dye is spin-coated on top of a transparent polycarbonate half disc about 0.6 mm thick and 12 cm in diameter with a pattern of features in the form of pregrooves suitable for DVD-R or DVD+R injection molded by a suitable stamper, and, dried. Subsequently, a reflective layer of copper based alloy approximately 65 nm in thickness is deposited or coated on the recording dye using the sputtering target with the aforementioned composition in a magnetron sputtering machine. Afterwards, this half disc is bonded to another 0.6 mm thickness half disc using a UV cured resin. Information is recorded onto the disc in a DVD-R or DVD+R recorder and the quality of the electronic signal is measured.

The disc is then subjected to an accelerated aging test. The disc is held at 70 degrees C. and 50% RH for 40 days. Afterwards, the reflectivity and the electronic signals are measured again and no significant changes are observed as compared to the same measurements before aging test.

### Example 7

A process to make the sputtering target with the composition as indicated in example 6 is described hereafter. Suitable charges of copper and nickel are put into the crucible of a suitable vacuum induction furnace. The vacuum furnace is pumped down to vacuum pressure of approximately 1 milli-torr and then induction heating is used to heat the charge. While the charge is heating up and the out-gassing finished, the furnace can be back filled with argon gas to a pressure of about 0.2 to 0.4 atmospheres. Casting of the liquid melt can be accomplished at a temperature approximately 10% above the melting point of the charge. The graphite crucible holding the melt can be equipped with a graphite stopper at the bottom of the crucible.

Pouring of the molten metal into individual molds of each sputtering target can be accomplished by opening, and closing, the graphite stopper in synchrony with mechanically placing each mold into position just underneath the melting crucible to that the proper amount of melt is poured and cast into each mold. Afterwards, additional argon flow into the vacuum furnace can be introduced to cool and quench the casting. Subsequently, a cold or warm multi-directional rolling process that causes a more than 50% reduction in thickness can be used to break up any non-uniform casting microstructure.

Then the final anneal is done at 550 to 600 degrees C. in a protective atmosphere for 15 to 30 minutes. After being machined into the right shape and size, cleaned in detergent and properly dried, the finished sputtering target is ready to be put into a magnetron sputtering apparatus to coat optical discs.

### Example 8

A copper alloy sputtering target having the composition given in a/o % of: 1% Ag; 1% Mg; 5% Zn; and balance copper was used to produce the reflective layer in a rewritable phase change disc structure such as DVD+RW, DVD-RW or DVD-RAM. Referring now to FIG. 5, successive layers of ZnO.SiO₂, Ag—In—Sb—Te, and ZnO.SiO₂ of suitable thickness are coated on a 0.6 mm thick polycarbonate substrate which has continuous spiral tracks of grooves and lands made by injection molding from a suitable stamper. Next, a sputtering target with the aforementioned composition is used in a magnetron sputtering apparatus to deposit a silver alloy film about 150 nm thick on top of the ZnO.SiO₂ film. Subsequently, the half disc is bonded with a suitable adhesive to the another 0.6 mm thick half disc of the same construction as the aforementioned half disc to form a complete disc.

Repeated record and erase cycles are performed in a suitable DVD+RW, DVD-RW or DVD-RAM drive. The disc meets the performance requirements imposed on the recording medium. The disc further under goes an accelerated environmental test at 80 degrees C., 85% relative humidity for 4 days. Afterwards, disc performance is checked again, no significant change in the disc property is observed as compared to the disc's performance before the environmental test.

All references, patents, patent application and the like cited herein and not otherwise specifically incorporated by references in their entirety, are hereby incorporated by references in their entirety as if each were separately incorporated by reference in their entirety.

An abstract is included in to aid in searching the contents of the abstract are not intended to be read as explaining, summarizing or otherwise characterizing or limiting the invention in any way.

I claim:

1. An optical storage medium, comprising:
at least one layer having a pattern of features in at least one major surface;
at least one reflective coating adjacent to at least one layer having a pattern of features in at least one major surface said reflective layer including a metal alloy, said metal alloy including copper, silver and magnesium, wherein the relationship between the amounts of copper, silver and magnesium in said metal alloy is defined by CuₓAg_{y}Mg_{z}, wherein 0.9<x<0.9998, 0.0001<y<0.05 and 0.0001<z<0.05.

2. The optical storage medium according to claim 1, further including at least one optical recording layer adjacent to said at least one reflective coating.

3. The optical storage medium according to claim 2, wherein said optical recording layer includes a dye selected from the group comprising cyanine compounds, azo compounds and phthalocyanine compounds.

4. The optical storage medium according to claim 1, wherein 0.97<x<0.997, 0.001<y<0.015, 0.001<z<0.03.

5. The optical storage medium according to claim 1, wherein said metal alloy further includes between 0.1 and 10.0 a/o percent zinc.

6. An optical storage medium, comprising:
at least one layer having a pattern of features in at least one major surface;
at least one reflective layer adjacent to at least one layer having a pattern of features in at least one major surface said reflective layer including a metal alloy, said metal alloy including copper, silver and zinc, wherein the relationship between the amounts of copper, silver and zinc in said metal alloy is defined by CuₓAg_{y}Znᵤ, wherein 0.85<x<0.9998, 0.0001<y<0.05 and 0.0001<u<0.10.

7. The optical storage medium according to claim 6, further including at least one optical recording layer adjacent to said at least one reflective coating.

8. The optical storage medium according to claim 7, wherein said optical recording layer includes a dye selected from the group comprising cyanine compounds, azo compounds and phthalocyanine compounds.

9. An optical storage medium, comprising:
at least one layer having a pattern of features in at least one major surface;
at least one reflective layer adjacent to at least one layer having a pattern of features in at least one major surface said reflective layer including a metal alloy, said metal alloy including copper, magnesium and nickel, wherein the relationship between the amounts of copper, magnesium and nickel in said metal alloy is defined by CuₓMg_{y}Niᵥ, wherein 0.85<x<0.9998, 0.0001<z<0.05 and 0.0001<v<0.10.

10. An optical storage medium, comprising:
at least one layer having a pattern of features in at least one major surface;
at least one reflective layer adjacent to at least one layer having a pattern of features in at least one major surface said reflective layer including a metal alloy, said metal alloy including copper, silver and zinc, wherein the relationship between the amounts of copper, silver and zinc in said metal alloy is defined by CuₓAg_{y}Znᵤ, wherein 0.85<x<0.9998, 0.0001<y<0.05 and 0.0001<u<0.10.

11. The optical storage medium according to claim 10, further including at least one optical recording layer adjacent to said at least one reflective coating.

12. The optical storage medium according to claim 11, wherein said optical recording layer includes a dye selected from the group comprising cyanine compounds, azo compounds and phthalocyanine compounds.

13. An optical storage medium, comprising:
at least one layer having a pattern of features in at least one major surface;
at least one reflective layer adjacent to at least one layer having a pattern of features in at least one major surface said reflective layer including a metal alloy, said metal alloy including copper, zinc and magnesium, wherein the relationship between the amounts of copper, zinc, and magnesium in said metal alloy is defined by CuₓZn_{y}Mg_{z}, wherein 0.85<x<0.9998, 0.0001<u<0.10, and 0.0001<z<0.05.

14. The optical storage medium according to claim 13, wherein said metal alloy further includes between 0.1 and 5.0 a/o percent nickel.

15. An optical storage medium, comprising:
at least one layer having a pattern of features in at least one major surface;
at least one reflective layer adjacent to at least one layer having a pattern of features in at least one major surface said reflective layer including a metal alloy, said metal alloy including copper, silver and nickel, wherein the relationship between the amounts of copper, silver and nickel in said metal alloy is defined by CuₓAg_{y}Niᵥ, wherein 0.85<x<0.9998, 0.0001<y<0.05 and 0.0001<v<0.10.

16. The optical storage medium according to claims 15, wherein said metal alloy further includes at one additional element selected from the group consisting of Co, B, Al, In or mixtures thereof, wherein said additional element is present in said metal alloy in the amount of between about 0.01 to about 5.0 a/o percent of copper in said metal alloy.

17. The optical storage medium according to claim 15, further including at least one optical recording layer adjacent to said at least one reflective coating.

18. The optical storage medium according to claim 17, wherein said optical recording layer includes a dye selected from the group comprising cyanine compounds, azo compounds and phthalocyanine compounds.

19. The optical storage medium according to claim 15, wherein said metal alloy further includes between 0.1 and 5.0 a/0 percent zinc.

20. An optical storage medium, comprising:
at least one layer having a pattern of features in at least one major surface;
at least one reflective layer adjacent to at least one layer having a pattern of features in at least one major surface said reflective layer including a metal alloy, said metal alloy including copper, and nickel, wherein the relationship between the amounts of copper and nickel in said metal alloy is defined by CuₓNiᵥ, wherein 0.80<x<0.9999, 0.0001<v<0.20.

21. The optical storage medium according to claim 20, further including at least one optical recording layer adjacent to said at least one reflective coating.

22. The optical storage medium according to claim 21, wherein said optical recording layer includes a dye selected from the group comprising cyanine compounds, azo compounds and phthalocyanine compounds.

23. The optical storage medium according to claim 20, wherein the amount of nickel in said alloy is given by 0.0001<v<0.01.

24. An optical storage medium, comprising:
at least one layer having a pattern of features in at least one major surface;
at least one reflective layer adjacent to at least one layer having a pattern of features in at least one major surface said reflective layer including a metal alloy, said metal alloy including copper, and zinc, wherein the relationship between the amounts of copper and zinc in said metal alloy is defined by CuₓZnᵤ, wherein 0.90<x<0.9999, 0.0001<u<0.10.

25. The optical storage medium according to claim 24, wherein the said metal alloy further includes at least one additional element selected from the group consisting of Co, B, Al, In and mixture thereof, wherein said additional element is present in said metal alloy in the amount of between about 0.01 to about 5.0 a/o percent of the copper present in the alloy.

26. The optical storage medium according to claim 24, further including at least one optical recording layer adjacent to said at least one reflective coating.

27. The optical storage medium according to claim 26, wherein said optical recording layer includes a dye selected from the group comprising cyanine compounds, azo compounds and phthalocyanine compounds.
